(19) United States
(12) Patent Application Publication
(10) Pub. No.: US 2005/0002177 A1
(43) Pub. Date: Jan. 6, 2005

(54) Fantasy lamp comprising a light-permeable, liquid-containing hollow chamber and a multiturn drive for said hollow chamber

(76) Inventor: Alfred Ewald, Walluf (DE)

Correspondence Address: HOWARD C. MISKIN;C/O STOLL, MISKIN, & BADIE, THE EMPIRE STATE BUILDING, 350 FIFTH AVENUE SUITE 4710, NEW YORK, NY, 10118, US

(21) Appl. No.: 10/475,240

(22) PCT Filed: Apr. 18, 2001
(86) PCT No.: PCT/IB01/00924

(51) Int. Cl. F21V 33/00

(52) U.S. Cl. 362/96; 362/154

(57) ABSTRACT

This invention relates to a fantasy lamp comprising a narrow, transparent hollow chamber (15) which receives at least two immiscible liquids and the back of which can be illuminated, wherein the hollow chamber comprises wall sections (13, 14) disposed at a slight distance from each other. The hollow chamber can be rotated about a substantially horizontal axis (10) when the wall sections are aligned substantially vertically. At least one of the liquids is coloured.

An electric motor drive (4), which is mounted in a chassis (1), is provided for rotating the hollow chamber (9). The hollow chamber (15) forms a component of a cover (9), and the drive (4) cooperates with a radially outer region (18) of the cover (9). When the hollow chamber is slowly rotated about the substantially horizontal axis, particular aesthetic effects can be achieved due to the liquids by means of a fantasy lamp which is fashioned in this manner. The lamp is of simple construction and can be manufactured as a mass-produced product in an economically acceptable manner.

Various lamps are known in which aesthetic effects are produced by two or more immiscible liquids, which are generally of different colours.

The present invention relates, for example, to that type of fantasy lamps such as these in which the effects are produced in a very narrow hollow chamber filled with liquids. A plurality of hollow chambers can be disposed side by side, and can also be disposed one behind the other. The respective hollow chamber is of circular construction, for example, and when it is disposed substantially vertically it slowly rotates, particularly about its centre.

According to the prior art, particularly narrow hollow chambers consist of plane parallel glass or plastic sheets, in which the sheets in the interior which form the walls are at a spacing of about 0.5 to 2.0 mm.

In one of these lamps, glass sheets are preferably disposed at a particularly short distance from each other, so that the during the slow rotational movement of the hollow chamber the immiscible liquids do not rapidly separate into layers with horizontal interfaces due to their different densities, which would not give rise to attractive aesthetic effects.

There are new hollow chamber lenses, which generally have diameters of up to 20 cm, and which are set in slow rotation, particularly in front of projector lamps, wherein the flowing image which is thus formed and which comprises “liquid bubbles” of different shapes and colours is projected on to surfaces in the room, and an indirect projection of the flow process is thus obtained.

The technique of manufacturing hollow chamber lenses such as these is costly and necessitates considerable manual labour. The glass sheets have to be cut mechanically and have to be adhesively bonded at their edges whilst maintaining a defined spacing. The introduction of liquids is very time-consuming here, since they only flow slowly into the very narrow hollow chamber. Moreover, a part which is generally metallic has to be adhesively bonded in the middle of one of the sides of hollow chamber lenses such as these, so that the hollow chamber lens can be attached to a motor shaft. The hollow chamber lenses are thus mounted centrally.

As a whole, this type of construction is unsuitable both for cost-effective mass-production and for hollow chamber lenses of larger diameters which enable the observer to experience the flow process directly, i.e. without projection on to surfaces.

In another variant (“DECOFLUID/Form+Farbe” catalogue published by Decofluid Form+Farbe GmbH, D-7470 Albstadt 2), which is fashioned according to the precharacterising clause of claim 1, the hollow chambers consist of plane parallel, transparent plastic sheets with diameters up to about 75 cm. These are illuminated electrically at their back, which acts as a diffuser for white light, and provide the observer with a direct flowing image of immiscible liquids of different colours. The larger diameter, and particularly the very much greater flexibility of plastics sheets compared with glass sheets, necessitates other measures here in order to prevent the liquids separating into approximately horizontal sheets.

These measures consist of inserting a plastics film in the space between the sheets, which has kinks and in which punched apertures are provided for spacers. During the slow rotation, the kink lines, which are opposite each other on both sides and which also intersect each other, contact the inner walls of the plastics sheets and thus prevent the liquids from being able to separate rapidly.

A prerequisite for the latter, however, is that at these larger diameters the two sheets which form the walls necessitate additional plastics parts in the form of spacers which keep the spacing between the plates constant as far as possible. Distortion of the hollow chamber due to the static pressure of the liquids is thereby prevented.

During the rotation of the hollow chamber, the liquids are entrained upwards due to the effect of the drive, and attractive aesthetic effects are produced by the partial downflow of the liquids from upper regions of the hollow chamber.

The disadvantage of this variant which comprises plane parallel plastic sheets is that the wall thickness of the sheets has to be kept relatively great, since due to the static pressure of the liquids the walls would be distorted outwards too much, even if spacers were employed in the lower regions, and the kinks in the inserted film would no longer contact the surfaces of the sheets, which would result in the liquids no longer being entrained substantially upwards when the hollow chamber lens rotates. This would lead to a considerable reduction in the aesthetic appeal of the flow process. Moreover, hollow chamber lenses such as these are very heavy as a whole. This necessitates a central bore in the middle, which is a disadvantage aesthetically, which bore in turn is fitted with perforated sheets made of plastics of greater or lesser width to provide liquid-tight separation. This results in a centre which does not display the coloured liquids. The same applies to the regions of the spacers.

Moreover, for these heavy hollow chamber lenses a relatively heavy motor is necessary which is disposed in the region of the central bore of the hollow chamber lens, and a relatively heavy chassis is necessary for all the components together, which include a decorative frame or covering frame.

Overall, fantasy lamps which are manufactured in this manner are so costly that they are unsuitable for cost-effective mass-production.

A filter lens which can be rotated is known from DE-G M 70 03 817, and comprises a narrow, transparent hollow chamber which contains two immiscible liquids and the back of which can be illuminated. The hollow chamber comprises flat wall sections which are disposed at a slight spacing from each other and which are joined by means of webs. These webs constitute obstacles to the liquids and gas bubbles which are in motion, and particular types of flow or swirls are formed on them, which results in particular optical effects. In addition, particles of solid materials can be situated in the hollow chamber. The filter lens is driven by providing it at its periphery with a toothed ring for a rotary drive.

A trans-illuminated liquid mobile is known from DE 297 08 792 U1. This comprises a horizontally disposed glass vessel which receives two immiscible, transparent, coloured liquids. The glass vessel can be swivelled to and fro about an axis by means of an assembly of rods which can be driven by an electric motor, so that it is set in upward and downward motion and is trans-illuminated by an upwardly directed source of illumination.

A rotationally symmetrical illumination body which can be rotated about its axis of rotation is known from DE-GM 17 29 617. On its curved, concave outer faces, the body is covered with coloured reflectors which are illuminated.

The object of the present invention is to further develop a fantasy lamp according to the precharacterising clause of claim I so that it can be manufactured in an economically acceptable manner as a mass-produced product.

This object is achieved by a fantasy lamp having the features of claim 1. It is thus essential to the invention that the hollow chamber forms a component of the cover, and that the drive cooperates with a radially outer region of the cover. In contrast to the prior art, the drive of the hollow chamber is thus not disposed centrally, but is disposed in the outer region of the hollow chamber.

In order to produce aesthetic effects due to the liquids, the hollow chamber, which is illuminated from the back, is set in slow rotary motion. According to the invention, this is effected by means of the motor drive.

For motor-driven rotary motion, the back wall part is advantageously first extended upwards by a few millimetres away from an encircling groove-like indentation and is then extended a few centimetres away from the centre, in order ultimately to extend into a hollow cylindrical ring with a width of several centimetres. In this manner, the hollow chamber forms a component of a cover. The hollow space which is thus formed and which is open at the back essentially performs two functions. Space for wheels, rollers or the like which form part of the drive is thus created in the edge region at the front. The central region behind the actual liquid-filled hollow chamber is necessary for the space which is required by the incandescent bulbs, neon tubes or the like (hereinafter called lamps) which are necessary for illumination.

The rotary movement of the hollow chamber lens is advantageously produced by the off-centre fixation of a motor with gearing in the vicinity of the edge, preferably in the top region, in a chassis which consists of metal or plastics and the external dimensions of which are somewhat smaller than those of the cover. The end shaft of this drive unit is provided with a wheel, roller, gearwheel or the like which fits into a complementary structure which is an encircling structure and which is also is situated at the front at about the height of the liquid space.

For instance, the drive mechanism can comprise a roller on the end shaft of the motor and an annular structure on the inside of the cylindrical edge region. The rotary movement of the entire cover is achieved by suspending it on the drive element of the motor. The annular structure or other suitable structure can be produced in conjunction to a certain extent during the thermal shaping of the back half of the chamber. However, it has also proved to be useful if said suitable structure is predetermined by a separate part. For a drive roller, for instance, this could be a ring made of metal or plastics which is pressed into a groove in the cylindrical edge region which is moulded during the main moulding operation.

In addition to the aforementioned aesthetic improvements, the advantage of this construction compared with those in which the hollow chamber lens is fixed centrally is that the cover can be removed by the movement of a hand, namely without the use of tools. This enables burnt-out lamps to be replaced in a very simple manner.

In general, however, simply providing a wheel, roller, gearwheel or the like will be insufficient for an article of commerce according to the perfect present invention which fulfils all the requirements imposed on it. Additional guide elements, in the form of one or two further rollers for instance, are used in order to stabilise the cover against lateral and oscillating movements. So that the cover can easily be removed by the user when the lamp is replaced, it is possible to fashion the guide element for the cover in particular so that it is not fixed to a rigid shaft on the chassis. Instead of this, the shaft is pressed against the encircling guide rail or the like in the cover by a spring or by the force of gravity of the guide element. This guide element can be snapped out of the guide rail by a lever effect, by employing a movement of the hand at the back of the chassis. The entire cover can then be removed.

For the sake of completeness, it should be mentioned that when the hollow chamber lens is trans-illuminated electrically the chassis also performs the function of receiving lamps, holders and electrical wires and a suspension element for the preferred fixation to vertical surfaces such as walls, and optionally accommodates elements which enable the best possible distance from said surfaces to be set. It is also possible, however, for a fantasy lamp of this type to be constructed not only for fixation to a vertical surface, but also to be constructed in the form of a lamp with a stand for placement on horizontal surfaces are such as the surfaces of tables, for instance.

According to one preferred embodiment of the invention, flat, planar faces are abandoned in favour of curved faces. The wall sections of the hollow chamber, particularly of a hollow chamber formed as a lens, are therefore constructed in particular in the form of spherical shells. This is achieved in particular by employing thermal deformation (thermoforming) to impart a spherical shell structure to plastics sheets or plastics films which are obtainable in numerous forms and qualities. This further development thus results from the recognition that at a given wall thickness spherical or elliptical hollow bodies (which are hereinafter described as spherical shells or spherical shell-like or curved) are more dimensionally stable or more rigid than those in which the wall is flat or planar.

It is also possible, however to produce the walls in the form of spherical shells by plastics injection moulding. The back wall part is advantageously manufactured from a white translucent plastics material, the translucency of which is such that as much light as possible is allowed to pass through, but which prevents the passage of so much light that lamp parts, incandescent filaments, etc., impair the visual appearance of the lamp. The front wall part is clear and transparent. Both wall parts or wall sections are advantageously made from the same type of plastics material.

So that a hollow body can be produced from two wall parts which comprise the wall sections, an encircling, spacing-defining edge is formed at the same time as at least one of the wall parts, so that when the two halves are assembled the desired spacing is produced in the interior of the hollow chamber. The shape of a spherical shell has a series of advantages for the new fantasy lamp, for example a smaller amount of plastics is required for each visible face, which results in a smaller, less costly motor; a lighter chassis which is thus inexpensive; and a significantly improved appearance, since the observer's field of view is impaired neither by a central perforated disc nor by spacers. The observer is presented with an area, particularly a circular area, which is not masked by anything, and which solely displays the effects of the liquids as far as the edge of the hollow chamber lens.

One significant further development of the invention is the new type of structure of the interior space of the hollow chamber or hollow chamber lens. Instead of a film which has to be provided with kinks in a costly manner, a completely plane plastics film is employed, which is unworked apart from punching out the outer boundary.

Thus a relatively thin film, which is preferably circular and which has a diameter which is somewhat smaller than the inside diameter of the hollow chamber, is inserted centrally in the hollow chamber. When the two wall halves are assembled, the planar film is forced to adapt to the curvature of the walls which are in the shape of spherical shells, whereby it increasingly assumes the shape of corrugations towards its edge. The crests of the corrugations in the hollow chamber are seated against the surfaces of the two wall halves alternately. This gives rise to small, flat, funnel-shaped voids which are suitable for the upward entrainment of the liquids during the rotation of the hollow chamber lens, and any horizontal separation of the liquids is consequently prevented.

It has been shown the flowing image which is thus produced is considerably more attractive than all the other aforementioned effects achieved hitherto in fantasy lamps comprising narrow hollow chambers which have been mentioned above. This is because shapes in the form of flower petals are formed due to the funnel-shaped voids which diminish towards the centre.

Amongst other considerations, in order to produce a hollow chamber from prefabricated wall parts, these parts are have to be joined to each other in a liquid-tight manner in their edge regions. According to the current state of the art, two basic methods are principally available for this purpose, namely adhesive bonding and welding.

The cover of the fantasy lamp can be fashioned in various manners. In one embodiment, it is of two-part construction, provided that the plastics film is left out of consideration. One part constitutes the wall part which is substantially formed by the front wall section. The other part is formed by the back wall section and by that region of the cover which adjoins the latter, namely by the radially outer region of the cover, so that this second part forms the hollow space for receiving the drive and the lamps. One embodiment, which is particularly advantageous with regard to manufacturing and cost factors, provides for the cover to be fashioned in three parts. In this design, the individual wall parts, which are essentially formed by the front and rear wall sections, are preferably assembled to form a component which forms the hollow chamber and which thus contains the film and the liquids. The wall parts are joined to each other at their encircling, radially outer edges, for example by adhesive bonding or welding. Thus a third part of the cover only needs to be constructed as an annular element by which the units are joined, for example by welding or adhesive bonding. This third component of the cover has a sufficient axial depth for receiving the drive and the lamps.

One embodiment of the invention provides not only for a hollow chamber as described above to be employed for each lamp, but also provides for more than one lamp, which lamps are disposed side by side or one behind another.

The invention is not limited to the use of two immiscible liquids, one of which is coloured. A plurality of liquids can definitely also be provided, and these can definitely all be coloured.

Other features of the invention are presented in the description of the Figures and in the Figures themselves. It should be remarked that all the features and combinations of individual features constitute the essence of the present invention.

The invention is illustrated in the Figures with reference to diverse embodiments which are suitable for the fundamental use of the fantasy lamp, without being limited thereto. The Figures are schematic illustrations, as follows:

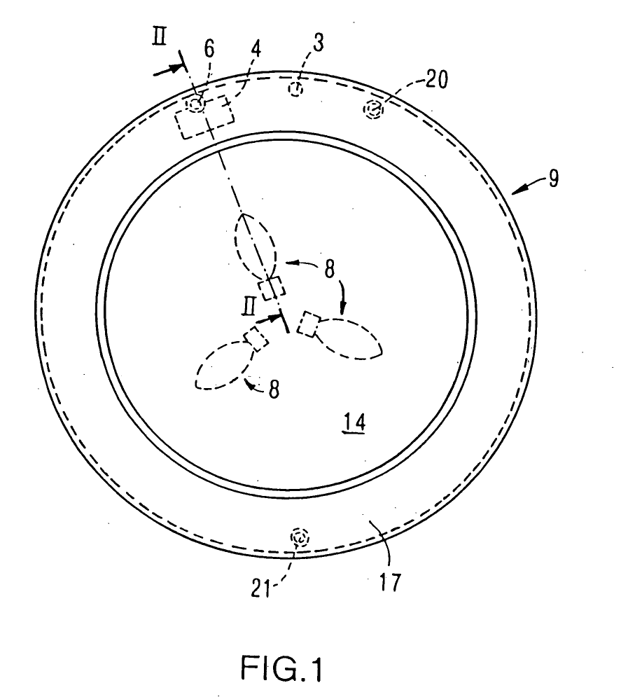

FIG. 1 is a front view of the fantasy lamp;

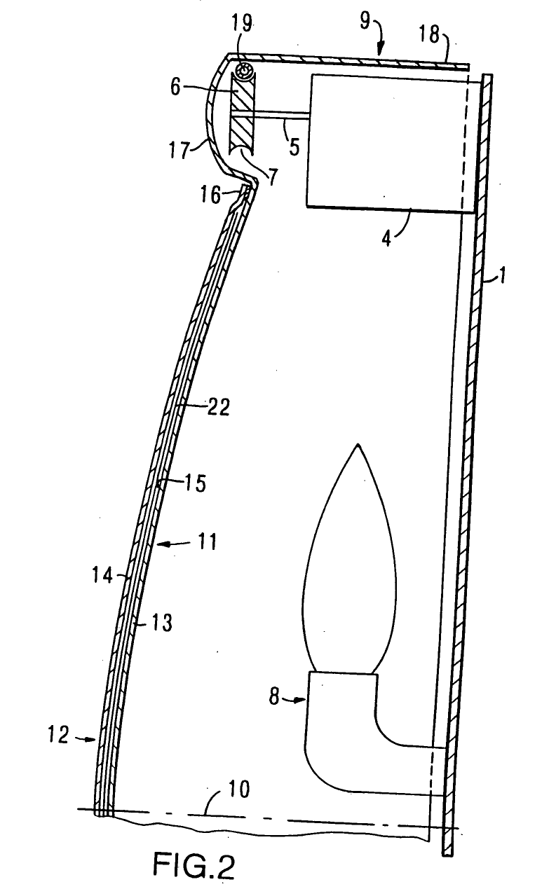

FIG. 2 is a section through the fantasy lamp along line II-II in FIG. 1;

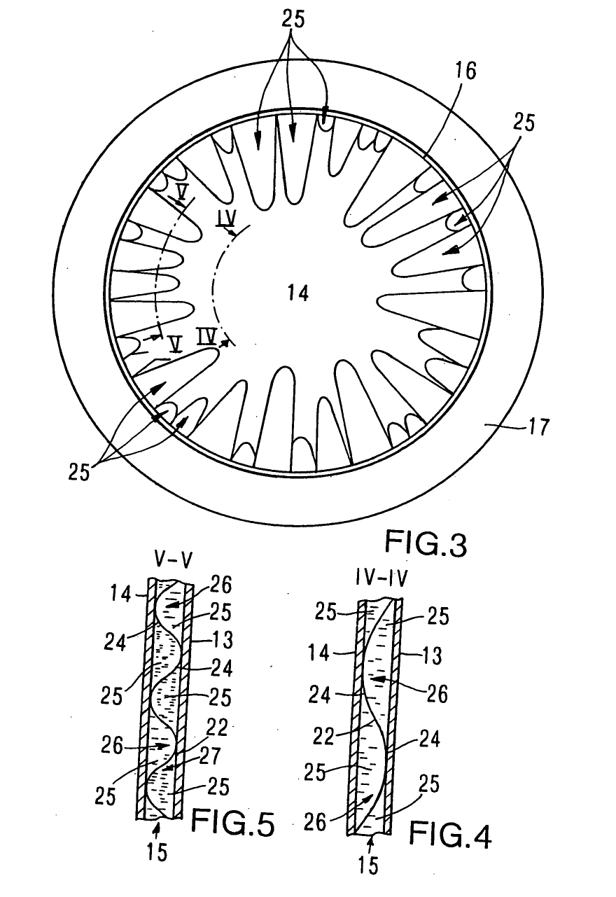

FIG. 3 is a view of the shell of the fantasy lamp, showing the flowing image when the shell is stationary and disposed horizontally;

FIG. 4 is an enlarged section through the shell in an inner region of the hollow chamber along line IV-IV in FIG. 3;

FIG. 5 is an enlarged section through the shell in an outer region of the hollow chamber along line V-V in FIG. 3;

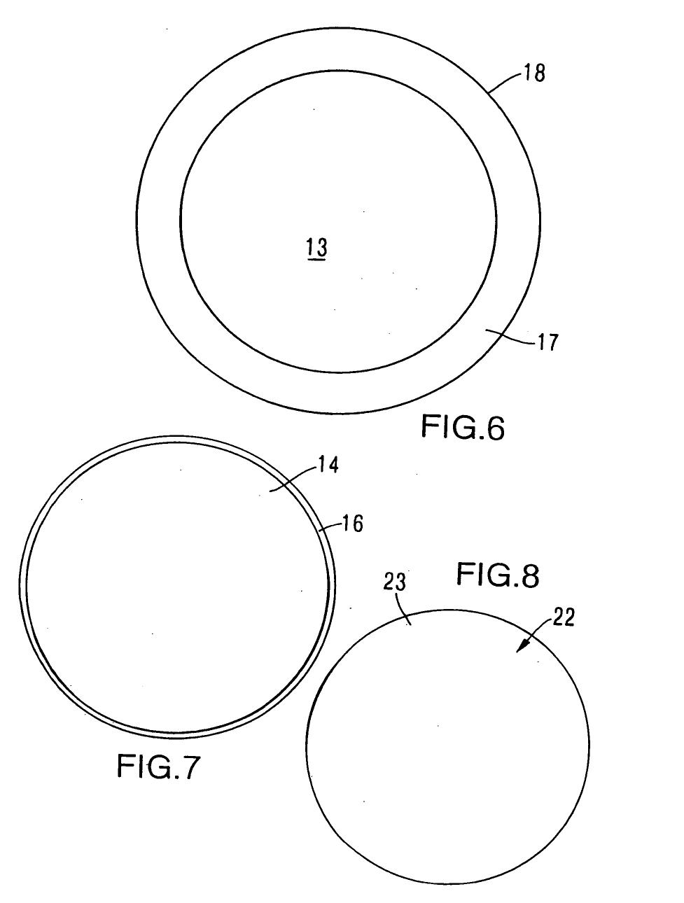

FIG. 6 is a front view of the shell:

FIG. 7 is a front view of the cover lens which can be attached to the shell;

FIG. 8 is a front view of the film which is inserted between the cover lens and the shell;

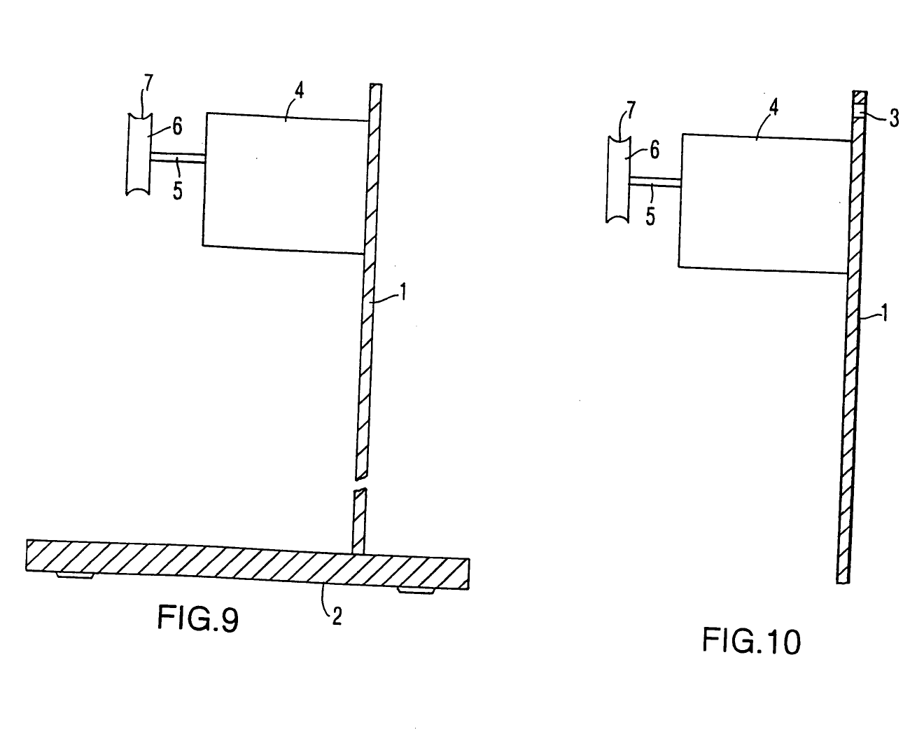

FIG. 9 shows a stand design for a suspended fantasy lamp, wherein only the stand elements and the drive for the fantasy lamp are shown;

FIG. 10 shows an embodiment of the fantasy lamp in which the chassis which. receives the drive is suspended, wherein the other parts of the fantasy lamp, such as those in FIG. 9, are not shown; and

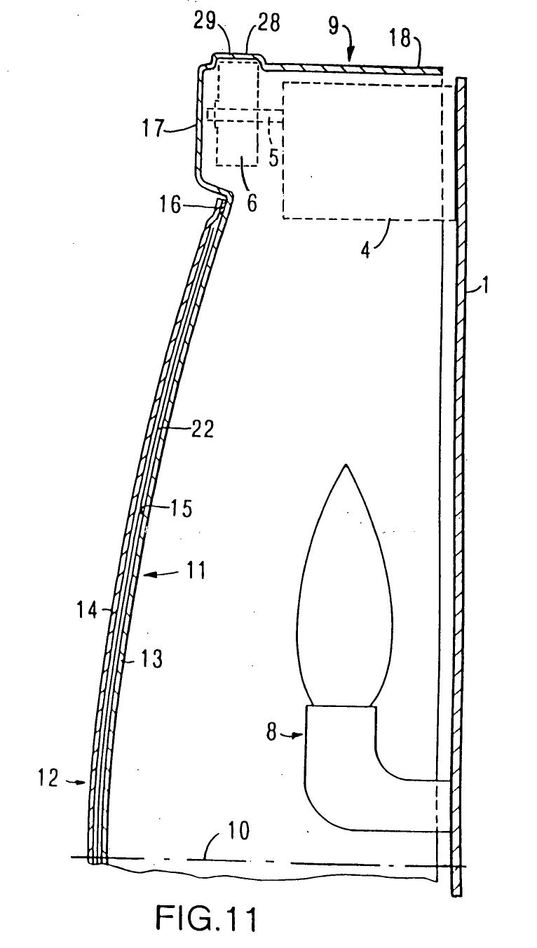

FIGS. 11 to 14 illustrate different embodiments of the construction of the cover of the fantasy lamp for the purpose of cooperating with an electric motor drive.

The fantasy lamp according to the invention comprises a chassis 1 constructed as a plate, which is oriented vertically and is either mounted in a horizontal base stand 2 as indicated in FIG. 9, or is suspended in the region of an upper aperture 3 as shown in FIG. 10. The chassis 1 is preferably formed as a circular plate. In its upper region, it receives a geared motor block 4 which is provided with an electrical connection, wherein the block 4 is positioned at a distance from the vertex of the chassis as shown in FIG. 1. An output shaft 5 of the block 4, which is oriented perpendicularly to the plate-shaped chassis 1, receives a drive wheel 6 which is fixed in rotation thereto and which is provided with an encircling groove 7. Its central region, the chassis 1 is provided with three lamps 8 arranged in the shape of a star on the side of the geared motor block 4.

A rotationally symmetrical cover 9 which in its fitted position covers the motor block 4, the lamps 8 and the chassis 1, can be set in slow rotary motion about its axis 10 by means of the drive. The cover 9 comprises a back wall part 11 which thus faces the lamps 8, and comprises a front wall part 12. The two wall parts 11 and 12 have parallel wall sections 13 and 14 which are curved outwards and which are thus curved away from the lamps 8 and which form a narrow hollow chamber 15 between them. The substantially constant distance of the wall sections 13 and 14 from each other is about 0.5 to 2.0 mm. The hollow chamber 15 constitutes the liquid space in the fantasy lamp. The back wall part 11 consists of a white, translucent plastics material which is permeable to light; the front wall part 12 is formed by a transparent plastic. An encircling edge 16 of the circular wall part 12 is constructed as a kind of recess and is adhesively bonded or welded to the wall part 11. The wall part 11 is provided, radially outside the adhesive bond or weld seam, with an encircling bulge 17 which is oriented outwards, through which the drive wheel 6 passes when the cover 9 is fitted. The horizontal, encircling edge region 18 of the wall part 11 is provided on the inside, in the region of the transition to the bulge 17, with an encircling guide rail which rests on the drive wheel 6. In order to guide the cover in a defined manner in relation to the chassis 1, a further wheel, which cannot be driven, however, is rotatably mounted on the chassis 1 with mirror symmetry in relation to the driven shaft 5 with respect to the aperture 3 for suspending the chassis 1, and another wheel 21, which co-operates with the guide rail 19, is rotatably mounted in a lower region of the chassis. The wheel 20 can be brought out of engagement with the guide rail 19, for example by means of the movement of a hand, which is not shown, on the back of the chassis 1, so that the cover 9 can be detached from the chassis 1 or can be placed thereon.

One aspect which is particularly important is that a transparent, relatively thin plastics film 22 is inserted in the hollow chamber 15 which is formed between the wall sections 12 and 13. In relation to the circular form of the wall sections 13 and 14 of the wall parts 11 and 12, this film 22—before it is placed between at the wall sections 13 and 14 —is completely flat and has a diameter which is somewhat smaller than the inside diameter of the hollow chamber 15. The film 22 is inserted centrally in a hollow chamber. When the two wall parts 11 and 12 are assembled, the flat film 22 is forced to adapt to the curvature of the wall sections 13 and 14 which have the form of spherical shells, whereby it increasingly forms corrugations towards the edge 23. The peaks 24 of the corrugations, with respect to which reference is made to the illustrations of FIGS. 3 to 5, are thereby seated in the hollow chamber on the surfaces of the two wall sections 13 and 14 alternately. This results in the formation of small, flat, funnel-shaped voids 25, which are suitable for an the upward entrainment of the different liquids situated in the hollow space when the hollow chamber lens rotates, and which are therefore suitable for counteracting any horizontal separation of the liquids. The illustrations of FIGS. 4 and 5 show two immiscible liquids 26 and 29 which are received by the hollow chamber, either one of which is coloured, or both of which can be of different colours. In particular, FIG. 4 shows that the same liquid can definitely flow into adjacent voids 20, for instance.

Due to the densities, which as a rule are different, of the liquids 26 and 27 which are received between the wall sections 13 and 14, these liquids will tend to separate when the cover 9 is stationary and is situated in its position of use, i.e. when it is aligned vertically. The lighter liquid is disposed in the upper region of the hollow chamber 15 and the heavier liquid is disposed in the lower region of the hollow chamber. Flowing images are not formed until the cover 9 slowly rotates. In order to provide an approximate illustration of the mode of action of the funnel-shaped voids 25, an illustration has been selected in FIG. 3 which does not relate to the vertical position of use of the cover 9 but which relates to a horizontal position of the cover 9 in which the wall section 14 is oriented upwards. In this situation, FIG. 3 illustrates a liquid distribution in which the lighter liquid mainly accumulates in the central region of the cover and the heavier liquid mainly accumulates in the outer region of the cover.

With respect to the embodiments shown in FIGS. 11 to 14, reference is made to the basic description of the embodiment shown in FIG. 2. In this respect, only the modifications shown in FIGS. 11 to 14 are described below:

In the embodiment shown in FIG. 11, as distinct from the embodiment shown in FIG. 2, the guide rail 19 disposed in the edge region 18 inside the cover 19 is dispensed with, and instead of this the cover 9 is provided there with a radially outwardly oriented, encircling recess 28, which comprises an encircling running face 29, which is parallel to the axis of rotation 10 of the cover, for the drive wheel 6 which is driven by the motor and which is constructed as a cylindrical roller, for example as a roller made of rubber. The axial dimension of the roller is calculated so that it fits into the recess 28 with a slight extent of clearance so that the cover 29 is axially guided over the roller 6.

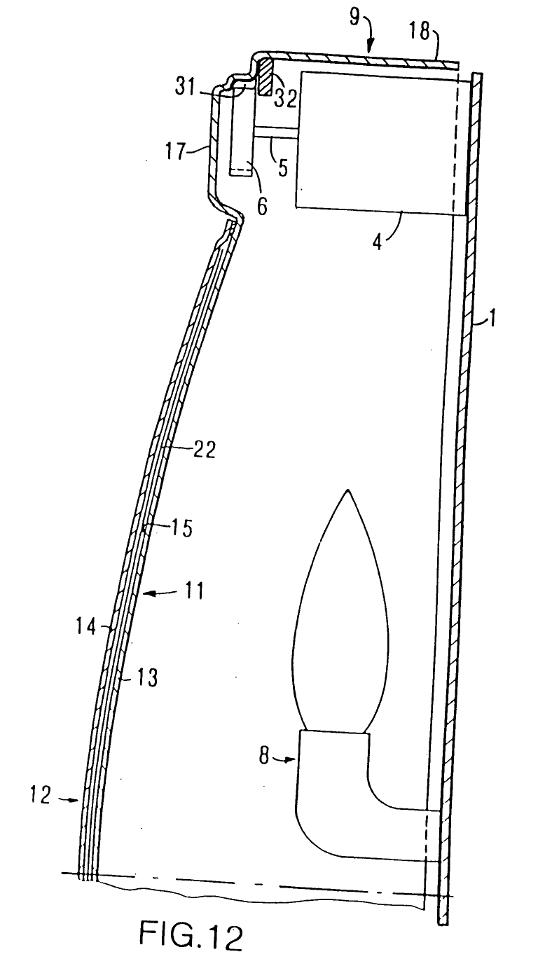

In the embodiment shown in FIG. 12, the cover 9 has a plurality of recesses in its edge region 18, wherein a middle recess 30 receives an encircling toothed ring 31 with which the drive wheel 6, which is constructed as a gearwheel, cooperates. The drive wheel is guided laterally firstly by a shoulder on the cover 9 and secondly by an encircling plastics or foam ring or tube 32 which is inserted in the shoulder of the radially outermost recess of the cover 9 in the transition to the middle recess 30, and which protrudes inwards into the region of the drive wheel 6.

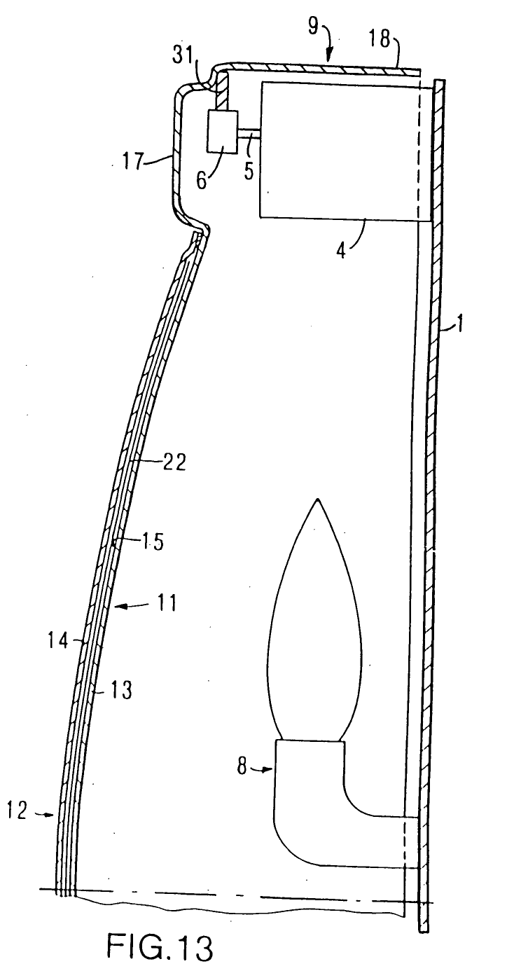

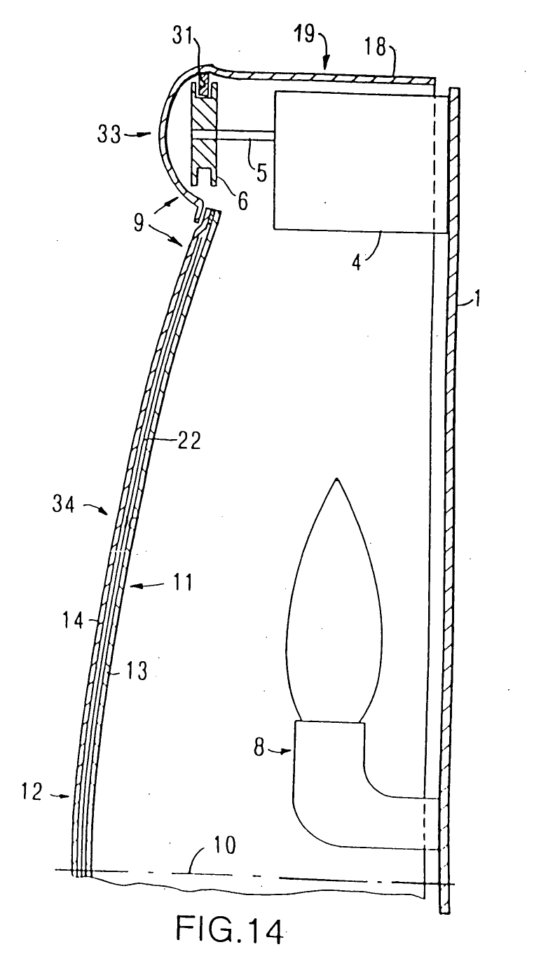

In the embodiment shown in FIG. 13, as distinct from the embodiment shown in FIG. 12, a middle recess is not provided, and the toothed ring 31 is positioned against the shoulder at the transition to the recess and is attached there to the cover 9, and in particular is adhesively bonded thereto. The drive wheel 6, which is constructed as a gearwheel, cooperates with the toothed ring 31. The flanks of the gearwheel can be of a slightly toroidal form, so that the toothed ring 31 and thus the cover 9 are axially guided in the gearwheel. This axial guidance can definitely be put into effect using an un-profiled gearwheel by means of the wheels 20 described above. These can be provided anyway in the other embodiments shown in FIGS. 11 and 12. The embodiment shown in FIG. 14 differs from that shown in FIG. 13 in that the cover 9 is not of two-part construction, but is of three-part construction, provided that the film 22 inserted in the hollow space 15 is left out of consideration. Thus the wall parts 11 and 12, which are substantially formed by the wall sections 13 and 14, are welded to each other at their radially outer edges, and this modular unit 34 is inserted radially outwardly into a radially outer annular cover part 13 and is attached thereto, by welding for example. The inner cover part 34 can thus be prefabricated as a modular unit and thus receives the film 22 and the liquids 26, 27 in its hollow space, so that the completion of the cover 9 only necessitates the joining of the inner cover part 34 to the outer cover part 33.

1. A fantasy lamp comprising a narrow, transparent, hollow chamber (15) which contains at least two immiscible liquids (26, 27) and on the back of which a means of illumination (8) is disposed, wherein the hollow chamber (15) comprises wall sections (13, 14) disposed at a slight distance from each other, wherein when the wall sections (13, 14) are aligned substantially vertically the hollow chamber (15) can rotate about a substantially horizontal axis (10), and an electric motor drive (4) is provided for rotating the hollow chamber (15) and is mounted in a chassis (1), and at least one of the liquids is coloured, characterised in that the hollow chamber (15) forms a component of a cover (9) and the drive (4) cooperates a with radially outer region (18) of the cover (9).

2. A lamp according to claim 1, characterised in that the cover (9) is suspended in relation to the drive (4).

3. A cover according to claims 1 or 2, characterised in that the drive (4) cooperates with the cover (9) at a distance from the top vertex of the cover (9).

4. A lamp according to any one of claims 1 to 3, characterised in that at least one guide element (20) for the cover (9) is disposed at a distance from the drive (4) in a radially outer region (18) of the cover (9).

5. A lamp according to claim 4, characterised in that a plurality of guide elements (20) is provided spaced apart from each other in order to stabilise the cover (9), wherein at least one of the guide elements (20) can be moved from an active position with the cover (9).

6. A lamp according to any one of claims 1 to 5, characterised in that the electric motor drive (4) comprises gearing.

7. A lamp according to any one of claims I to 6, characterised in that a drive element (6) of the drive engages in a complementary element (19, 28, 31) which is attached to the cover (9).

8. A lamp according to claim 7, characterised in that the drive element is fashioned as a wheel, a roller, a gearwheel or the like, and the complementary element is a fashioned as a rail (19), a rack (31) of curved construction, a recess (28) in the cover or the like.

9. A lamp according to any one of claims 1 to 8, characterised in that the cover (9) is of rotationally symmetrical form.

10. A lamp according to claim 9, characterised in that the cover (9) of rotationally symmetrical form comprises an outer, substantially axial edge (18) which is provided with the encircling complementary element (19, 28, 31).

11. A lamp according to any one of claims 7 to 10, characterised in that in the region of its radially outer edge (18) the cover (9) comprises an encircling bulge (17) which is oriented away from the chassis (1) and through which the drive element (6) of the drive (4) passes.

12. A lamp according to any one of claims 1 to 11, characterised in that at least one means of illumination (8) is disposed inside the cover (9).

13. A lamp at according to any one of claims 1 to 12, characterised in that the wall sections (13, 14) are of curved construction and are parallel, and a film (22) is inserted in the hollow chamber (15), wherein the film (22) is planar before it is inserted between the wall sections.

14. A lamp according to claim 13, characterised in that the wall sections (13, 14) of the hollow chamber are constructed as a spherical shells.

15. A lamp according to claims 13 or 14, characterised in that the film (22) is circular before it is inserted between the wall sections (13).

16. A lamp according to any one of claims 13 to 15, characterised in that funnel-shaped voids (25) are formed between the film (22) and the wall sections (13, 14) of the hollow chamber (15) and diminish towards the centre of the hollow chamber (15).

17. A lamp according to any one of claims 1 to 16, characterised in that the cover (9) comprises a radially outer cover part (33) and a radially inner cover part (34), wherein the inner cover part (34) is substantially formed by the two wall sections (13, 14).

18. A lamp according to claim 17, characterised in that the inner cover part (34) constitutes a prefabricated component, which is filled with the liquids (26, 27) and/or which is provided with the film (22), and to which the outer cover part (33) is attached, particularly by welding or adhesive bonding.
